(19) United States
(12) Patent Application Publication
(10) Pub. No.: US 2025/0264663 A1
(43) Pub. Date: Aug. 21, 2025

(54) 2X2 COUPLER

(71) Applicant: Cisco Technology, Inc., San Jose, CA (US)

(72) Inventors: Jean-Luc J. TAMBASCO, Macungie, PA (US); Dominic F. SIRIANI, Lansdale, PA (US)

(21) Appl. No.: 18/442,976

(22) Filed: Feb. 15, 2024

(51) Int. Cl. G02B 6/293

(52) U.S. Cl. CPC G02B 6/2938; G02B 6/2935

(57) ABSTRACT

A 2×2 coupler is disclosed. In one aspect, the 2×2 coupler includes a first stage configured as a mode multiplexer. The mode multiplexer includes two input waveguides that transition asymmetrically along a propagation axis of the 2×2 coupler so that an optical signal input into either of the two input waveguides traverses into the input waveguide that transitions from a single mode waveguide to a multimode waveguide. The 2×2 coupler also includes a second stage configured as a multimode splitter. The multimode splitter includes two single mode output waveguides and a multimode waveguide arranged in communication with the multimode waveguide of the mode multiplexer. The output waveguides and the multimode waveguide transition symmetrically along the propagation axis so that the optical signal traversing in the multimode waveguide of the mode multiplexer is received by the multimode waveguide of the multimode splitter and split into the two single mode output waveguides.

### TECHNICAL FIELD

Embodiments presented in this disclosure generally relate to photonic components. More specifically, embodiments disclosed herein relate to 2×2 couplers.

### BACKGROUND

2×2 couplers, such as adiabatic 2×2 3 dB splitters, are photonic components used to split or cross optical signals. 2×2 couplers can be implemented in a number of applications, including switches, modulators, interferometers, etc. As one example, an adiabatic 2×2 3 dB splitter can be used as an input and/or an output splitter of a photonic switch. Further, adiabatic splitters can be used as standalone devices. Generally, adiabatic splitters are desired to be minimal loss, compact, and fabrication tolerant. Adiabatic splitters are also designed to have a precise split ratio. Improvements to these metrics is desirable as improved optical performance, packaging, and/or manufacturability can result.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a top view of a 2×2 coupler according to one embodiment of the present disclosure.

FIG. 2 depicts various cross-sectional views of the 2×2 coupler of FIG. 1.

FIG. 3 is a top view of a 2×2 coupler according to another embodiment of the present disclosure.

FIG. 4 is a schematic flow diagram depicting an example manner in which optical signals can be split by the 2×2 coupler of FIG. 1.

FIG. 5 illustrates a matrix of cross-sections of the 2×2 coupler of FIG. 1 that demonstrate an example manner in which the 2×2 coupler can split optical signals.

FIG. 6 is a schematic view of a thermo-optic switch incorporating a 2×2 coupler according to one embodiment of the present disclosure.

FIG. 7 is a schematic view of an electro-optic switch incorporating a 2×2 coupler according to one embodiment of the present disclosure.

FIG. 8 is a schematic view of a laser switch incorporating a 2×2 coupler according to one embodiment of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a 2×2 coupler. The 2×2 coupler includes a first stage configured as a mode multiplexer and a second stage configured as a multimode splitter.

Another embodiment presented in this disclosure is a 2×2 coupler. The 2×2 coupler includes a first stage having two input waveguides that transition asymmetrically along a propagation axis of the 2×2 coupler so that an optical signal input into one of the two input waveguides traverses into, or remains in, a first input waveguide of the two input waveguides that transitions from a single mode waveguide to a multimode waveguide. Further, the 2×2 coupler includes a second stage having two single mode output waveguides and a multimode waveguide arranged in communication with the multimode waveguide of the first stage. The two single mode output waveguides and the multimode waveguide transition symmetrically along the propagation axis so that the optical signal traversing in the multimode waveguide of the first stage is received by the multimode waveguide of the second stage and split into the two single mode output waveguides.

Yet another embodiment presented in this disclosure is a 2×2 coupler. The 2×2 coupler includes a first stage having two input waveguides that transition asymmetrically along a propagation axis of the 2×2 coupler so that an optical signal input into a first input waveguide or a second input waveguide of the two input waveguides traverses into, or remains in, the first input waveguide that transitions from a single mode waveguide to a multimode waveguide. The first input waveguide inverse tapers while the second input waveguide tapers over at least a portion of the first stage as the first and second waveguides extend away from an inlet of the 2×2 coupler. The 2×2 coupler also includes a second stage having two single mode output waveguides and a multimode waveguide arranged in communication with the multimode waveguide of the first stage. The two single mode output waveguides and the multimode waveguide transition symmetrically along the propagation axis so that the optical signal traversing in the multimode waveguide of the first stage is received by the multimode waveguide of the second stage and split into the two single mode output waveguides.

### Example Embodiments

Various embodiments of 2×2 couplers are disclosed herein that can provide improved optical performance, packaging, and/or manufacturability over conventional 2×2 couplers. The disclosed 2×2 couplers can be used as standalone devices or can be implemented into various products, including, without limitation, switches (e.g., thermo-optic switches, electro-optic switches, laser switches, etc.), modulators, interferometers, other FR4 standard products, Co-Packaged Optics (CPO) applications, etc., and can be used in receiver, transmitter, and/or transceiver applications, among others.

In at least one example aspect, a 2×2 coupler having a mode multiplexer followed by a multimode splitter is disclosed. Specifically, the 2×2 coupler includes two stages, including a first stage configured as a mode multiplexer and a second stage configured as a multimode splitter. The mode multiplexer of the first stage functions to robustly move all or nearly all of an optical signal (or its optical power), which is input into one of two single mode input waveguides of the mode multiplexer, into a single multimode waveguide. In this way, the optical signal is prepared in the first stage for the sensitive part of the process-the splitting of the optical signal that takes place in the multimode splitter of the second stage. The mode multiplexer includes two input waveguides that transition asymmetrically along a propagation axis of the 2×2 coupler so that an optical signal input into one of the two input waveguides traverses into, or remains in, the input waveguide of the two input waveguides that transitions from a single mode waveguide to a multimode waveguide. The multimode splitter of the second stage includes two single mode output waveguides and a multimode waveguide arranged in communication with the multimode waveguide of the mode multiplexer. The output waveguides and the multimode waveguide transition symmetrically along the propagation axis so that the optical signal traversing in the multimode waveguide of the mode multiplexer is received by the multimode waveguide of the multimode splitter and split into the two single mode output waveguides, e.g., 50:50.

Accordingly, the sensitive process of splitting the optical signal takes place along a symmetric transition, which can improve the performance of the 2×2 coupler, including providing improved split ratio, lower insertion loss, and higher bandwidth. The symmetry of the multimode splitter of the second stage can eliminate or provide for an ultra-low crosstalk 2×2 coupler. Moreover, the 2×2 coupler disclosed herein can be fabricated with a reduced footprint and a more robust design that is more tolerant to fabrication deviations than conventional 2×2 designs. In addition, the 2×2 coupler disclosed herein can enable the use of silicon to form an adiabatic 2×2 coupler. Further, when the 2×2 coupler of the present disclosure is implemented as a Si adiabatic 2×2 coupler in devices that utilize phase-shifting devices, the 2×2 coupler disclosed herein can eliminate or reduce the need for additional interlayer transitions as the phase-shifting devices positioned relative to the 2×2 coupler are typically formed of silicon as well.

As used herein, the term “substantially” or a like word of approximation means within ten percent (10%) of a stated value, unless otherwise specified.

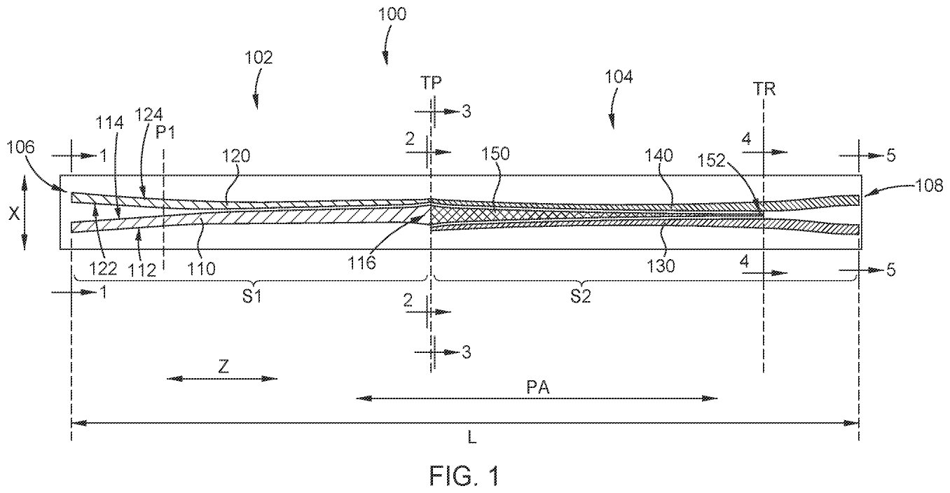

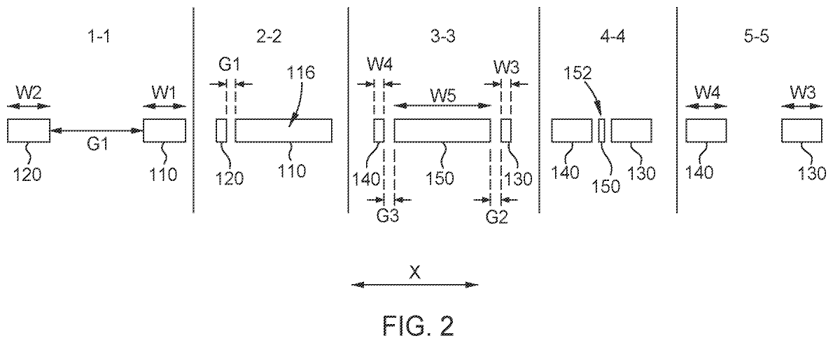

With reference to FIGS. 1 and 2, a 2×2 coupler 100 according to one example embodiment of the present disclosure is depicted. FIG. 1 is a top view of the 2×2 coupler 100 and FIG. 2 depicts various cross-sectional views of the 2×2 coupler 100. For reference, the 2×2 coupler 100 defines a longitudinal direction Z, a lateral direction X, and a vertical direction Y. The longitudinal direction Z, the lateral direction X, and the vertical direction Y are mutually perpendicular to one another and form an orthogonal direction system.

The 2×2 coupler 100 has a length L, a first stage S1 extending along a first portion of the length L, and a second stage S2 extending along a second portion of the length L. The second stage S2 follows or is adjacent to the first stage S1 as shown in FIG. 1. The first stage S1 transitions to the second stage S2 at a transition plane TP. For this example embodiment, the first stage S1 is configured as a mode multiplexer 102 and the second stage S2 is configured as a multimode 50:50 splitter, or multimode splitter 104. Generally, the mode multiplexer 102 of the first stage S1 prepares and feeds optical signals to the multimode splitter 104. The multimode splitter 104 splits the optical signals, e.g., 50:50 into separate output waveguides. The 2×2 coupler 100 has an input 106 and an output 108. In at least some embodiments, the 2×2 coupler 100 is made entirely of silicon. In this regard, the 2×2 coupler 100 can be an adiabatic 2×2 coupler. In some embodiments, the first stage S1 or the second stage S2 can be formed of silicon while the other stage can be formed of a different composition, such as silicon nitride. In this manner, in such embodiments, the 2×2 coupler 100 can be adiabatic in part.

The mode multiplexer 102 of the first stage S1 is configured as a two-mode multiplexer and is arranged asymmetrically along a propagation axis PA of the 2×2 coupler 100. The propagation axis PA extends along the longitudinal direction Z in this example embodiment. The mode multiplexer 102 has a first input waveguide 110 and a second input waveguide 120 that each traverse from the input 106 of the 2×2 coupler 100 to the transition plane TP. The first input waveguide 110 has a first width W1 and the second input waveguide 120 has a second width W2, e.g., as shown at 1-1 in FIG. 2, which is a cross section taken from line 1-1 in FIG. 1 at the input 106. The first input waveguide 110 has a first edge 112 and a second edge 114, which are spaced from one another along the lateral direction X. Likewise, the second input waveguide 120 has a first edge 122 and a second edge 124, which are spaced from one another along the lateral direction X. The first and second input waveguides 110, 120 have respective thicknesses extending along the vertical direction Y.

The first and second input waveguides 110, 120 are both single mode waveguides at the input 106 and for at least a portion of the first stage S1. For instance, the first input waveguide 110 can be configured to receive optical signals each having a first mode (e.g., TE0 mode optical signals, wherein TE denotes “Transverse Electric”) and the second input waveguide 120 can be configured to receive optical signals each having a second mode (e.g., TE1 mode optical signals). The first mode can be different than the second mode. Accordingly, the first and second input waveguides 110, 120 are configured to receive different mode optical signals.

In an initial portion of the first stage S1, the first and second input waveguides 110, 120 converge toward one another as depicted in FIG. 1. In this manner, a gap G1 defined between the first and second input waveguides 110, 120 decreases during the initial portion of the first stage S1. Once the first and second input waveguides 110, 120 are fully converged, the gap G1 between the first and second input waveguides 110, 120 can be maintained substantially constant until the transition plane TP. That is, the edge-to-edge gap G1 between the second edge 114 of the first input waveguide 110 and the first edge 122 of the second input waveguide 120 can be held substantially constant over at least a portion of the first stage S1.

As further shown in FIG. 1, the first and second input waveguides 110, 120 are arranged asymmetrically along the first stage S1 so that the first input waveguide 110 transitions from a single mode waveguide to a multimode waveguide, which can receive and guide first mode optical signals, e.g., TE0 mode optical signals received by the first input waveguide 110, or receive and guide second mode optical signals, e.g., TE1 mode optical signals received by the second input waveguide 120. Stated differently, the first and second input waveguides 110, 120 transition along the first stage S1 so as to render a single multimode waveguide at the transition plane TP. The first input waveguide 110 becomes the single multimode waveguide at least by the transition plane TP. In this regard, the first input waveguide 110 is a single mode waveguide at the input 106 but transitions into a multimode waveguide at least by the transition plane TP. The portion of the first input waveguide 110 arranged as a single multimode waveguide is denoted in FIG. 1 as single multimode waveguide 116 (see also the cross section 2-2 in FIG. 2).

The first input waveguide 110 becomes a “multimode” waveguide in that, at least by the transition plane TP, the first input waveguide 110 is operable to receive and guide optical signals having a first mode (e.g., TE0 mode optical signals), which are input into the first input waveguide 110 at the input 106, and also operable to receive and guide optical signals having a second mode (e.g., TE1 mode optical signals), which are input into the second input waveguide 120 at the input 106. For instance, when an optical signal having a first mode (e.g., a TE0 mode) is input into the first input waveguide 110 at the input 106, the optical signal having the first mode effectively remains within the same waveguide (i.e., the first input waveguide 110 that transitions from a single mode waveguide to a multimode waveguide) along the first stage S1. When an optical signal having a second mode (e.g., a TE1 mode) is input into the second input waveguide 120 at the input 106, the optical signal having the second mode effectively “jumps” over to the first input waveguide 110 at least by the transition plane TP.

The first input waveguide 110 transitions from a single mode waveguide to a multimode waveguide due to the geometry of the first and second input waveguides 110, 120 in a transition region of the first stage S1 (the transition region spans between the first plane P1 and the transition plane TP). The first plane P1 can be positioned between the input 106 and the transition plane TP along the longitudinal direction Z as shown in FIG. 1, or in other embodiments, the first plane P1 can be at the input 106. As illustrated in FIG. 1, the first input waveguide 110 inverse tapers (e.g., generally from the first plane P1 of the 2×2 coupler 100 to the transition plane TP) while the second input waveguide 120 tapers (e.g., generally from the first plane P1 to the transition plane TP). In this regard, the first width W1 of the first input waveguide 110 increases (e.g., gradually) while the second width W2 of the second input waveguide 120 decreases (e.g., gradually) during this transition region of the first stage S1. The second input waveguide 120 can taper so as to “disappear” or nearly disappear at the transition plane TP. This ensures that substantially all optical power (e.g., at least 95%) of an optical signal input into the second input waveguide 120 is contained in the single multimode waveguide at the transition plane TP (i.e., the first input waveguide 110 at the transition plane TP). The first and second waveguides 110, 120 are also arranged so that substantially all optical power (e.g., at least 95%) of an optical signal input into the first input waveguide 110 is contained in the single multimode waveguide at the transition plane TP (i.e., the first input waveguide 110 at the transition plane TP).

At 2-2 in FIG. 2, which is a cross section taken from line 2-2 in FIG. 1 at the transition plane TP, the second input waveguide 120 is shown having nearly disappeared while the first input waveguide 110 is at its widest width. Stated another way, the first width W1 of the first input waveguide 110 is greatest at the transition plane TP while the second width W2 of the second input waveguide 120 is smallest at the transition plane TP. The close edge-to-edge gap G1 and relatively large width of the first input waveguide 110 and relatively small width of the second input waveguide 120 allows an optical signal input into the second input waveguide 120 at the input 106 to “jump” or move to the first input waveguide 110 at least by the transition plane TP.

The multimode splitter 104 of the second stage S2 is arranged symmetrically along the propagation axis PA of the 2×2 coupler 100. For this example embodiment, the multimode splitter 104 is arranged as a multimode 50:50 y-splitter. However, in other embodiments, the multimode splitter 104 can have other symmetric arrangements.

As shown in FIG. 1, the multimode splitter 104 has a first output waveguide 130 and a second output waveguide 140. The first and second output waveguides 130, 140 each traverse from the transition plane TP to the output 108. The first and second output waveguides 130, 140 generally converge toward one another along the lateral direction X over an initial portion of the second stage S2 and then eventually diverge from one another along the lateral direction X as they approach the output 108 of the 2×2 coupler 100 over a latter portion of the second stage S2. The first and second output waveguides 130, 140 are each single mode waveguides. The first output waveguide 130 has a third width W3 and the second output waveguide 140 has a fourth width W4, e.g., as shown at 3-3 in FIG. 2, which is a cross section taken from line 3-3 in FIG. 1 at the transition plane TP. The widths W3, W4 of the first and second output waveguides 130, 140 can vary over their longitudinal lengths. The first and second output waveguides 130, 140 inverse taper (e.g., generally from the transition plane TP to the output 108). In some embodiments, the first and second output waveguides 130, 140 can inverse taper along a portion of the longitudinal length of the second stage S2. For instance, in some embodiments, the widths W3, W4 of the first and second output waveguides 130, 140 can inverse taper from the transition plane TP to a termination plane TR but then can remain substantially constant between the termination plane TR and the output 108. Accordingly, the widths W3, W4 of the first and second output waveguides 130, 140 can increase (e.g., gradually) over at least a portion of the second stage S2. The first and second output waveguides 130, 140 have respective thicknesses extending along the vertical direction Y.

The multimode splitter 104 also has a multimode waveguide 150 arranged between the first and second output waveguides 130, 140, e.g., along the lateral direction X. An edge-to-edge gap G2 is defined between the first output waveguide 130 and a first edge of the multimode waveguide 150 and an edge-to-edge gap G3 is defined between the second output waveguide 140 and a second edge of the multimode waveguide 150, e.g., as shown at 3-3 in FIG. 2. The gaps G2, G3 can remain substantially constant over the longitudinal length of the multimode waveguide 150. The multimode waveguide 150 has a fifth width W5, e.g., as shown at 3-3 in FIG. 2. The width W5 of the multimode waveguide 150 can vary over its longitudinal length. Indeed, the multimode waveguide 150 tapers (e.g., generally from the transition plane TP to the termination plane TR). In this regard, the fifth width W5 of the multimode waveguide 150 decreases (e.g., gradually) as the multimode waveguide 150 extends toward the output 108. The multimode waveguide 150 has a thickness extending along the vertical direction Y.

Moreover, the multimode waveguide 150 traverses from the transition plane TP to the termination plane TR. A terminal end 152 of the multimode waveguide 150 and the first and second output waveguides 130, 140 in relation to the terminal end 152 are shown at 4-4 in FIG. 2, which is a cross section taken from line 4-4 in FIG. 1 at the termination plane TR. The termination plane TR is arranged between the transition plane TP and the output 108 in the example embodiment. In this regard, the multimode waveguide 150 terminates before the output 108 of the 2×2 coupler 100. At 5-5 in FIG. 2, which is a cross section taken from line 5-5 in FIG. 1 at the output 108, the multimode waveguide 150 is not present and the widths W3, W4 of the first and second output waveguides 130, 140 are shown substantially equal.

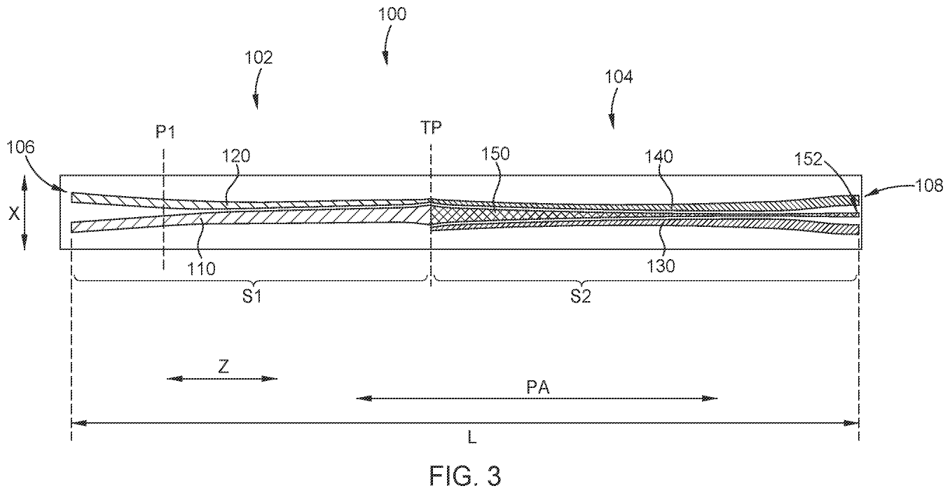

In some alternative embodiments, as shown in FIG. 3, the multimode waveguide 150 of the 2×2 coupler 100 can traverse longitudinally from the transition plane TP to the output 108. The terminal end 152 of the multimode waveguide 150 is depicted at the output 108. In this regard, the multimode waveguide 150 can have an “extended tip” in some embodiments. Such an arrangement can be advantageous for fabrication robustness, e.g., to avoid discontinuities until the first and second output waveguides 130, 140 are substantially decoupled, e.g., as they are arranged at the output 108.

As illustrated in FIG. 1, the multimode splitter 104 is also arranged in communication with the single multimode waveguide of the first stage S1 (i.e., the first input waveguide 110 at the transition plane TP). That is, at the transition plane TP, the multimode waveguide 150 is in communication with the single multimode waveguide of the mode multiplexer 102 (i.e., the first input waveguide 110 at the transition plane TP). In some embodiments, the width W5 of the multimode waveguide 150 is substantially equal to the width of the single multimode waveguide of the mode multiplexer 102 at the transition plane TP (i.e., the width W1 of the first input waveguide 110 at the transition plane TP). Stated another way, at the transition plane TP, the fifth width W5 is substantially equal to the first width W1.

Notably, the first and second output waveguides 130, 140 and the multimode waveguide 150 transition symmetrically along the second stage S2 so that an optical signal traversing in the multimode waveguide of the first stage S1 (i.e., the first input waveguide 110 at the transition plane TP) is received by the multimode waveguide 150 of the second stage S2 and split substantially equally into the first and second output waveguides 130, 140. In this way, the splitting of an optical signal is accomplished with a splitter having a symmetric arrangement.

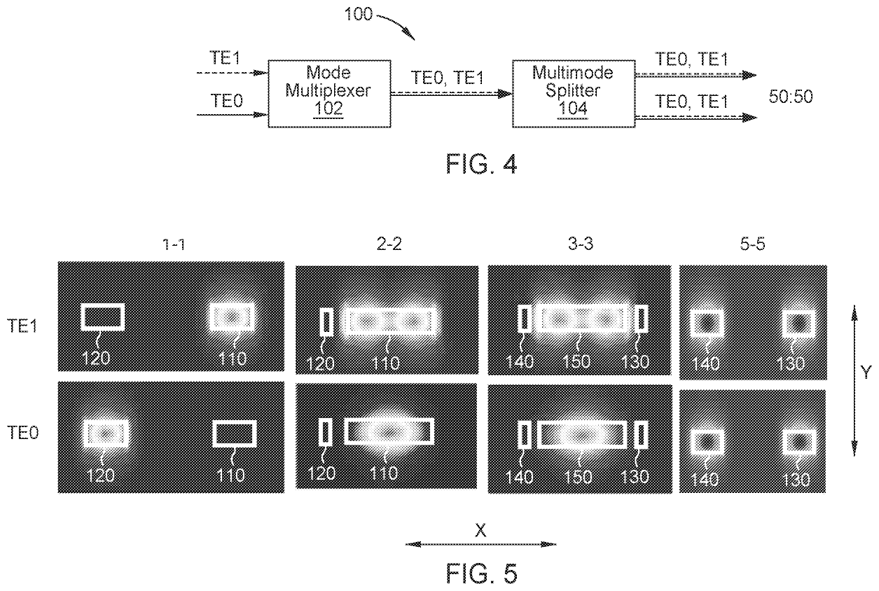

With reference now to FIGS. 4 and 5, an example manner in which optical signals can be split by the 2×2 coupler 100 will be provided. FIG. 4 is a schematic flow diagram depicting an example manner in which optical signals can be split by the 2×2 coupler 100. FIG. 5 illustrates a matrix of cross-sections of the 2×2 coupler 100 that demonstrate how the 2×2 coupler 100 splits light, according to an example embodiment.

As shown in FIGS. 4 and 5, a first mode optical signal and a second mode optical signal can enter the 2×2 coupler 100, e.g., through respective input ports of the first and second input waveguides 110, 120. In this example, the first mode optical signal is a TE0 mode optical signal and the second mode optical signal is a TE1 mode optical signal.

With respect to the TE0 mode optical signal, the TE0 mode optical signal is input into the first input waveguide 110 of the mode multiplexer 102 as illustrated in FIG. 5 at the cross section 1-1. The first input waveguide 110 is a single mode waveguide at the input 106 (FIG. 1), or at the cross section 1-1. As described above, the first and second input waveguides 110, 120 transition asymmetrically along the first stage S1 (FIG. 1) so that the first input waveguide 110 transitions from a single mode waveguide to a multimode waveguide. At the transition plane TP (FIG. 1), or at cross section 2-2, the first input waveguide 110 is a multimode waveguide and the second input waveguide 120 “disappears” or nearly disappears. Accordingly, all or nearly all of the optical power of the TE0 mode optical signal traversing through the first stage S1 is contained within the first input waveguide 110 at cross section 2-2, e.g., as shown in FIG. 5.

The TE0 mode optical signal propagates across the transition plane TP (FIG. 1) and into the multimode splitter 104, and at the cross section 3-3 (which is just after the transition plane TP in the second stage S2), the TE0 mode optical signal traverses along the multimode waveguide 150 as shown in FIG. 5. As described above, the first and second output waveguides 130, 140 and the multimode waveguide 150 transition symmetrically along the second stage S2 and are arranged so that the TE0 mode optical signal substantially equally splits into the first and second output waveguides 130, 140. As illustrated in FIG. 5 at the cross section 5-5, the TE0 mode optical signal has split 50:50 between the first output waveguide 130 and the second output waveguide 140 at the output 108 (FIG. 1).

With respect to the TE1 mode optical signal, the TE1 mode optical signal is input into the second input waveguide 120 of the mode multiplexer 102 as illustrated in FIG. 5 at the cross section 1-1. The second input waveguide 120 is a single mode waveguide at the input 106 (FIG. 1), or at the cross section 1-1. As noted above, the first and second input waveguides 110, 120 transition asymmetrically along the first stage S1 (FIG. 1) so that the first input waveguide 110 transitions from a single mode waveguide to a multimode waveguide and so that the second input waveguide 120 “disappears” or nearly disappears as the second input waveguide 120 approaches the transition plane TP (FIG. 1). The first input waveguide 110 can inverse taper along at least a portion of the first stage S1 to increase in width and the second input waveguide 120 can taper along at least a portion of the first stage S1 to decrease in width. Accordingly, the TE1 mode optical signal input into the second input waveguide 120 “jumps” over or goes into the multimode section of the first input waveguide 110. Thus, all or nearly all (e.g., at least 90%) of the optical power of the TE1 mode optical signal traversing through the first stage S1 is contained within the first input waveguide 110 at cross section 2-2 as shown in FIG. 5.

The TE1 mode optical signal propagates across the transition plane TP (FIG. 1) and into the multimode splitter 104, and at the cross section 3-3 (which is just after the transition plane TP in the second stage S2), the TE1 mode optical signal traverses along the multimode waveguide 150 as shown in FIG. 5. As described above, the first and second output waveguides 130, 140 and the multimode waveguide 150 transition symmetrically along the second stage S2 and are arranged so that the TE1 mode optical signal substantially equally splits into the first and second output waveguides 130, 140. As illustrated in FIG. 5 at the cross section 5-5, the TE1 mode optical signal has split 50:50 between the first output waveguide 130 and the second output waveguide 140 at the output 108 (FIG. 1).

Accordingly, the 2×2 coupler 100 outputs the TE0 mode optical signal 50:50 between the first output waveguide 130 and the second output waveguide 140 and the TE1 mode optical signal 50:50 between the first output waveguide 130 and the second output waveguide 140 as shown in FIGS. 4 and 5.

Embodiments of the 2×2 coupler 100 disclosed herein can be used in a Mach Zehnder device, such as a switch, interferometer, or modulator. Examples are provided below.

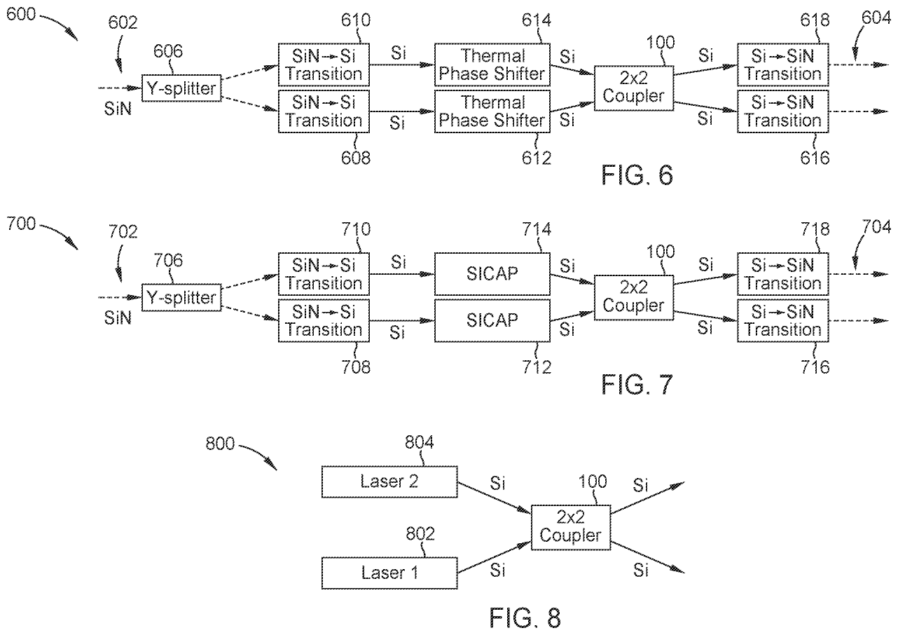

As one example, FIG. 6 is a schematic view of a thermo-optic switch 600 incorporating the 2×2 coupler 100 therein. In this example, the thermo-optic switch 600 is a thermo-optic 1×2 switch having one input and two outputs. The thermo-optic switch 600 can be used in a receiver circuit, for example. As shown, the thermo-optic switch 600 has an input 602 and an output 604. The thermo-optic switch 600 includes a y-splitter 606, first and second transitions 608, 610, first and second thermal phase shifters 612, 614, the 2×2 coupler 100, and third and fourth transitions 616, 618. Generally, the y-splitter 606 can split optical signals into two portions, the first and second transitions 608, 610 can transition their respective optical paths from Silicon Nitride (SiN) to Silicon (Si), the first and second thermal phase shifters 612, 614 can change the phase of their respective portions of the optical signals by locally controlling the temperature in a phase-shifting region, the 2×2 coupler 100 can receive different optical signals having different modes in its respective input waveguides and can split the modes equally between its output waveguides as described in detail herein, and the third and fourth transitions 616, 618 can transition their respective optical paths from Si to SiN. Use of the 2×2 coupler 100 can improve the performance of the thermo-optic switch 600. Moreover, such a configuration can enable the 2×2 coupler 100 to be entirely formed of Si, which make the 2×2 coupler 100 an adiabatic 2×2 coupler.

As another example, FIG. 7 is a schematic view of an electro-optic switch 700 incorporating the 2×2 coupler 100 therein. In this example, the electro-optic switch 700 is an electro-optic 1×2 switch having one input and two outputs. The electro-optic switch 700 can be used in a transmitter circuit, for example. As shown, the electro-optic switch 700 has an input 702 and an output 704. The electro-optic switch 700 includes a y-splitter 706, first and second transitions 708, 710, first and second electro-optic phase shifters 712, 714, the 2×2 coupler 100, and third and fourth transitions 716, 718. Generally, the y-splitter 706 can split optical signals into two portions, the first and second transitions 708, 710 can transition their respective optical paths from SiN to Si, the first and second electro-optic phase shifters 712, 714 can change the phase of their respective portions of the optical signals, the 2×2 coupler 100 can receive different optical signals having different modes in its respective input waveguides and can split the modes equally between its output waveguides as described in detail herein, and the third and fourth transitions 716, 718 can transition their respective optical paths from Si to SiN. Use of the 2×2 coupler 100 can improve the performance of the electro-optic switch 700. Moreover, such a configuration can enable the 2×2 coupler 100 to be entirely formed of Si, which make the 2×2 coupler 100 an adiabatic 2×2 coupler.

As yet another example, FIG. 8 is a schematic view of a laser switch 800 incorporating the 2×2 coupler 100 therein. In this example, the laser switch 800 allows for selection between a first laser 802 and a second laser 804. When the first laser 802 is selected, the first laser 802 emits an optical signal (or laser beam of a first mode), the 2×2 coupler 100 formed of Si can receive the optical signal. Particularly, the first stage of the 2×2 coupler configured as a mode multiplexer can have a first input waveguide and a second input waveguide that transition asymmetrically over the first stage. The optical signal can be received by the first input waveguide and can traverse through the first stage of the 2×2 coupler 100 so as to be contained in a single multimode waveguide before crossing the transition plane into the second stage of the 2×2 coupler. For instance, the optical signal can remain in the first input waveguide which transitions from a single mode input waveguide to a multimode waveguide. The second stage of the 2×2 coupler configured as a symmetric splitter can split the optical signal between its first and second output waveguides and output the split portions from the 2×2 coupler.

When the second laser 804 is selected, the second laser 804 emits an optical signal (or laser beam of a second mode), the 2×2 coupler 100 can receive the optical signal. Specifically, the optical signal can be received by the second input waveguide and can traverse through the first stage of the 2×2 coupler 100 so as to be contained in a single multimode waveguide before crossing the transition plane into the second stage of the 2×2 coupler. For instance, the optical signal can “jump” or go from the second input waveguide to a segment of the first input waveguide that has transitioned to a multimode waveguide. The second stage of the 2×2 coupler configured as a symmetric splitter can split the optical signal between its first and second output waveguides and output the split portions from the 2×2 coupler. Although the 2×2 coupler 100 is shown in FIG. 8 as being formed of Si, in other embodiments, the 2×2 coupler 100 of FIG. 8 can be formed of SiN.

It will be appreciated that the switches 600, 700, 800 depicted in FIGS. 6, 7, and 8 are provided by way of example and are not intended to be limiting. The 2×2 coupler disclosed herein can be implemented in other configurations, systems, circuits, as stand-alone devices, etc.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s).

In view of the foregoing, the scope of the present disclosure is determined by the claims that follow.

We claim:

1. A 2×2 coupler, comprising:
a first stage configured as a mode multiplexer; and
a second stage configured as a multimode splitter.

2. The 2×2 coupler of claim 1, wherein the first stage transitions to the second stage at a transition plane, and wherein at the transition plane, substantially all optical power of an optical signal traversing through the 2×2 coupler is contained within a single multimode waveguide.

3. The 2×2 coupler of claim 1, wherein the first stage transitions to the second stage at a transition plane, and wherein the mode multiplexer has a first input waveguide and a second input waveguide that each traverse from an input to the transition plane, and wherein the first and second input waveguides are arranged asymmetrically along a propagation axis of the 2×2 coupler.

4. The 2×2 coupler of claim 3, wherein the first stage transitions to the second stage at a transition plane, and wherein the first input waveguide and the second input waveguide are single mode waveguides at an input of the 2×2 coupler and the first and second input waveguides transition along the first stage so as to render a single multimode waveguide at least at the transition plane.

5. The 2×2 coupler of claim 4, wherein the first input waveguide becomes the single multimode waveguide at the transition plane while the second input waveguide tapers as the second input waveguide approaches the transition plane so that substantially all optical power of an optical signal input into the second input waveguide is contained in the single multimode waveguide at the transition plane.

6. The 2×2 coupler of claim 1, wherein the mode multiplexer is arranged as a two-mode multiplexer.

7. The 2×2 coupler of claim 1, wherein the multimode splitter is arranged symmetrically along a propagation axis of the 2×2 coupler.

8. The 2×2 coupler of claim 1, wherein the multimode splitter is arranged as a multimode y-splitter.

9. The 2×2 coupler of claim 8, wherein the multimode y-splitter has a multimode waveguide that tapers and two output waveguides that inverse taper.

10. The 2×2 coupler of claim 9, wherein the first stage transitions to the second stage at a transition plane, and wherein, at the transition plane, the multimode waveguide is in communication with a single multimode waveguide of the mode multiplexer.

11. The 2×2 coupler of claim 9, wherein the multimode waveguide is arranged between the two output waveguides.

12. The 2×2 coupler of claim 9, wherein the multimode waveguide terminates before an output of the 2×2 coupler.

13. The 2×2 coupler of claim 9, wherein the two output waveguides diverge from one another as they approach an output of the 2×2 coupler.

14. The 2×2 coupler of claim 9, wherein the 2×2 coupler is made entirely of silicon.

15. A 2×2 coupler, comprising:
a first stage having two input waveguides that transition asymmetrically along a propagation axis of the 2×2 coupler so that an optical signal input into one of the two input waveguides traverses into, or remains in, a first input waveguide of the two input waveguides, wherein the first input waveguide transitions from a single mode waveguide to a multimode waveguide; and
a second stage having two single mode output waveguides and a multimode waveguide arranged in communication with the multimode waveguide of the first stage, the two single mode output waveguides and the multimode waveguide transition symmetrically along the propagation axis so that the optical signal traversing in the multimode waveguide of the first stage is received by the multimode waveguide of the second stage and split into the two single mode output waveguides.

16. The 2×2 coupler of claim 15, wherein the 2×2 coupler is an adiabatic 2×2 coupler.

17. The 2×2 coupler of claim 15, wherein the first input waveguide inverse tapers along at least a portion of the first stage and a second input waveguide of the two input waveguides tapers along at least a portion of the first stage.

18. The 2×2 coupler of claim 17, wherein the first input waveguide and the second input waveguide converge toward one another from an input of the 2×2 coupler to a first plane arranged between the input and a transition plane defined where the first stage transitions to the second stage.

19. The 2×2 coupler of claim 15, wherein the multimode waveguide of the second stage is arranged between the two single mode output waveguides and tapers over at least a portion of the second stage as the multimode waveguide extends away from the first stage while the two single mode output waveguides both inverse taper over at least a portion of the second stage as the two single mode output waveguides extend away from the first stage.

20. A Mach Zehnder device, comprising:
a 2×2 coupler, comprising:
a first stage having two input waveguides that transition asymmetrically along a propagation axis of the 2×2 coupler so that an optical signal input into a first input waveguide or a second input waveguide of the two input waveguides traverses into, or remains in, the first input waveguide, wherein the first input waveguide transitions from a single mode waveguide to a multimode waveguide, and wherein the first input waveguide inverse tapers while the second input waveguide tapers over at least a portion of the first stage as the first and second waveguides extend away from an inlet of the 2×2 coupler; and
a second stage having two single mode output waveguides and a multimode waveguide arranged in communication with the multimode waveguide of the first stage, the two single mode output waveguides and the multimode waveguide transition symmetrically along the propagation axis so that the optical signal traversing in the multimode waveguide of the first stage is received by the multimode waveguide of the second stage and split into the two single mode output waveguides.
